(19) United States
(12) Patent Application Publication
(10) Pub. No.: US 2020/0279340 A1
(43) Pub. Date: Sep. 3, 2020

(54) Optimal Convex Hull Pricing Procedure for Electricity Whole Sale Market

(71) Applicant: Midcontinent Independent System Operator, Inc., Carmel, IN (US)

(72) Inventors: Yongpei GUAN, Gainesville, FL (US); Yonghong CHEN, Zionsville, IN (US)

(73) Assignee: Midcontinent Independent System Operator, Inc., Carmel, IN (US)

(21) Appl. No.: 16/804,984

(22) Filed: Feb. 28, 2020

Related U.S. Application Data
(60) Provisional application No. 62/812,634, filed on Mar. 1, 2019.

(51) Int. Cl. G06Q 50/06; H02J 3/38; G06Q 40/04; G06Q 30/08; G06Q 30/02

(52) U.S. Cl. CPC G06Q 50/06; H02J 3/381; G06Q 30/0206; G06Q 30/08; G06Q 40/04

(57) ABSTRACT

Reducing uplift payments has been a challenging problem for most wholesale markets in US. The main difficulty comes from the unit commitment discrete decision makings. Recently convex hull pricing has been shown promising to reduce the uplift payments. Meanwhile, however, the computation could be heavy to decide the convex hull price. This disclosure shows how to utilize a derived integral formulation of the single-generator unit commitment problem to facilitate the calculation of the optimal convex hull price by solving a linear program.

### CROSS REFERENCE TO RELATED APPLICATIONS

The current application claims priority to U.S. Provisional Application, Ser. No. 62/812,634, filed Mar. 1, 2019, the entire disclosure of which is incorporated herein by reference.

### BACKGROUND

For most wholesale electricity grid markets in the U.S., Independent System Operators (ISOs) (also referred to herein as “Controllers”) collect the bids from the generation and load sides and then run the security-constrained unit commitment (SCUC) problem to decide the local marginal prices (LMPs) for transactions. As indicated in [1], the unit commitment (UC) problem is in general a mixed-integer program, in which the convexity is not maintained. Thus, there could be no set of uniform prices that supports a welfare-maximizing solution. For instance, a generation unit could have a “lost opportunity cost,” which is defined as the gap between a unit's maximum possible profit under the clearing price and the actual profit obtained by following the ISO's solution. To address this issue, one approach is still to maintain uniform energy prices based on marginal energy costs and meanwhile ISOs pay the side payments to units, so as to cover their “lost opportunity costs.” This payment is referred to as “uplift” payment. In other words, due to the non-convexity of the SCUC problems, there is a positive non-zero gap between the objective value of the primal formulation used by ISOs and the sum of the objectives of the profit maximization models used by each market participant. ISOs need to pay this positive non-zero gap, i.e., uplift payment, to the resources owned by market participants. To minimize the uplift payments, a convex hull pricing approach was recently introduced and received significant attention [1], [2], [3]. This pricing approach aims to minimize the uplift payments over all possible uniform prices. The Midcontinent ISO has implemented an approximation of convex hull pricing, named extended locational marginal prices [4].

In general, the optimization problem of minimizing the uplift payments is computationally challenging. The main difficulties lie in two aspects: 1) discrete decision variables (on and off statuses of each generator) in the formulation and 2) general convex functions of the generation costs. To address these, significant progress has been made in [2], among others, in which a convex hull description for the UC polytope without considering ramping is introduced and convex envelop is introduced to reformulate the problem as a second-order cone programming. For real world market clearing problems, more advanced convex hull UC formulation with consideration of generator physical constraints including ramping is required.

### SUMMARY

In this disclosure, an integral formulation as described in [5] is introduced for the single-generator UC problem. The integral formulation can provide an integral solution for a general single-generator UC problem considering min-up/-down time, generation capacity, ramping and variant start-up cost restrictions with a general convex cost function.

In an aspect of the current disclosure a method for operating an electrical power grid is provided. The electrical power grid includes an electrical power grid, a plurality of power generation participants providing electric power to the electrical power grid, a plurality of consumers drawing electrical power from the electrical power grid, and a Controller that administers the market for the power generation participants and the consumers on the electrical power grid. The method includes: collecting bids, by the controller, from the power generation participants and the power generation recipients; and setting, by the controller, one or more uniform prices for the providing of electric power from the power generation participants to the power generations consumers; where the setting step utilizes a convex hull pricing approach; and where the convex hull pricing approach utilizes an integral formulation of the single-generator unit commitment problem to facilitate the calculation of an accurate convex hull price that achieves the most efficient market clearing price. In a detailed embodiment, the calculation of the improved convex hull price involves only solving a linear program, and the calculation has guaranteed convergence and fast solving time for practical real-world application.

### BRIEF DESCRIPTION OF THE DRAWINGS

FIG. 1 is a block-diagram representation of an exemplary electric power grid according to the current disclosure; and

FIG. 2 is a flow diagram representation of a market clearing process according to the current disclosure.

### DETAILED DESCRIPTION

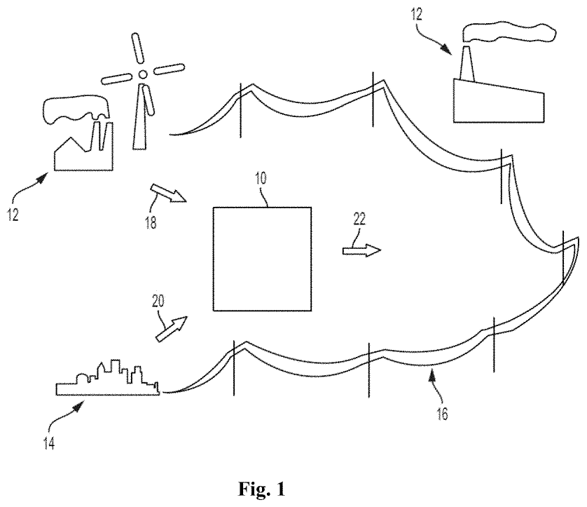

Referring to FIG. 1, an exemplary ISO or controller 10, according to the current disclosure, administers the market for electricity producers 12 and users 14 on an electric power grid 16. Some exemplary functions of the controller 10 include monitoring energy transfers on the transmission system, scheduling transmission service, managing power congestion, operating DA and RT energy and operating reserves (“OR”) markets, and regional transmission planning. Both the electricity producers 12 and the users 14 may be considered to be market participants (MPs) as they conduct business within the controller's 10 region. Traditionally, the electricity producers will provide offers 18 of electrical power and the users will provide bids 20 for power. The controller 10 will process the offers 18 and bids 20 with consideration of the transfer limits on grid 16 to determine commitments of electrical power and then controlling the dispatch 22 of electricity flowing through the grid 16 based upon the commitments.

### I. An Integral Formulation

Notation. For a T-period problem, let L (l) be the min-up (-down) time limit, C̅ (C) be the generation upper (lower) bound when the generator is online, V be the start-up/shut-down ramp rate, and V be the ramp-up/-down rate in the stable generation region. Binary decision variable wₜ represents whether the generator starts at time t for the first time (wₜ=1) or not (wₜ=0), binary decision variable yₜₖ represents whether the generator starts up at t and shuts down at k+1 (yₜₖ=1) or not (yₜₖ=0), binary decision variable zₜₖ represents whether the generator shuts down at time t+1 and starts up again at time k (zₜₖ=1) or not (zₜₖ=0), and binary decision variable θₜ represents whether the generator shuts down at time t+1 and stays offline to the end (θₜ=1) or not (θₜ=0). Further, let qₜₖ^{s} be the generation amount at time s corresponding to the “on” interval yₜₖ=1. The corresponding generation cost ƒₜₖ^{s}(qₜₖ^{s}) is usually denoted as a convex function ƒ̅ₜₖ^{s}(qₜₖ^{s})=aₛ(qₜₖ^{s})²+bₛqₜₖ^{s}+cₛ. The following formulation described in [5] (formulation (8) in [5]) based on a revised dynamic programming can provide an integral solution, in which the general convex cost function is approximated by a piecewise linear function with N pieces (N can be a very large number). That is, instead of solving a mixed-integer program with a convex cost function, the optimal solution can be obtained by solving the following linear program if ƒₜₖ^{s}(qₜₖ^{s}) is approximated by a piecewise linear function with N pieces as in most practice. We denote this formulation as new UC (NUC) formulation.

$$\begin{matrix}min {\sum }_{t = 1}^{T} {g}^{+} ( {s}_{o} + t - 1 ) {w}_{t} + {\sum }_{t = 1}^{T} {\sum }_{k = t + L - 1}^{T - 1} {g}^{-} ( k - t + 1 ) {𝓎}_{tk} + {\sum }_{t = L}^{T - 𝓁 - 1} {\sum }_{k = t + 𝓁 + 1}^{T} {g}^{+} ( k - t - 1 ) {z}_{t k} + {\sum }_{tk ϵ TK} {\sum }_{s = t}^{k} {φ}_{tk}^{s} & ( 1 ) \\ s . t . {\sum }_{t = 1}^{T} {w}_{t} \leq 1 , & ( 2 ) \\ {\sum }_{k = m i n \{ t + L - 1 , T \}}^{T} {𝒴}_{tk} - {\sum }_{K = L}^{t - 𝓁 - 1} {z}_{k t} = {w}_{t} , ∀ t ∈ {[ 1 , T ]}_{ℤ} , & ( 3 ) \\ {\sum }_{k = 1}^{t - L + 1} {𝒴}_{k t} - {\sum }_{k = t + 𝓁 + 1}^{T} {z}_{tk} = {θ}_{t} , ∀ t ∈ {[ L , T - 𝓁 - 1 ]}_{ℤ} , & ( 4 ) \\ \underline{C} {𝓎}_{tk} \leq {q}_{tk}^{s} \leq \overline{C} {𝓎}_{tk} , ∀ s ∈ {[ t , k ]}_{ℤ} , ∀ tk ∈ TK , & ( 5 ) \\ {q}_{t k}^{k} \leq \overline{V} {𝓎}_{tk} , ∀ tk ∈ TK , & ( 6 ) \\ {q}_{tk}^{k} \leq \overline{V} {𝓎}_{tk} , ∀ tk ∈ TK , k \leq T - 1 & ( 7 ) \\ {q}_{tk}^{s - 1} - {q}_{tk}^{s} \leq V {𝓎}_{tk} , {∀}_{s} ∈ {[ t + 1 , k ]}_{ℤ} , ∀ tk ∈ TK , & ( 8 ) \\ {q}_{tk}^{s} - {q}_{tk}^{s - 1} \leq V {𝓎}_{tk} , {∀}_{s} ∈ {[ t + 1 , k ]}_{ℤ} , ∀ t k ∈ TK , & ( 9 ) \\ {φ}_{tk}^{s} - {m}_{j} {q}_{tk}^{s} \geq {n}_{j} {𝓎}_{tk} , {∀}_{s} ∈ {[ t , k ]}_{ℤ} , {∀}_{j} ∈ {[ 1 , N ]}_{ℤ} , {∀}_{tk} , & ( 10 ) \\ w , θ , y , z \geq 0 , & ( 11 )\end{matrix}$$

where TK represents the set of all possible combinations of each t∈[1, T]_{Z} and each k∈[min{t+L−1, T}, T]_{Z} to construct a time interval [t, k]_{Z}, g⁺(s) represents the start-up cost when the generator has been down for s time units (with parameter s₀ being the initial down time for the generator), g⁻(s) represents the shut-down cost when the generator has been up for s time units. Constraints (2) to (4) keep track of the “on” and “off” statuses of the unit.

Constraints (5) represent the generation upper and lower bounds. Constraints (6) and (7) represent the start-up and shut-down ramping restrictions. Constraints (8) and (9) represent the ramp-up and ramp-down restrictions. Constraints (10) represent the piecewise linear approximation of the general convex function ƒₜₖ^{s}(qₜₖ^{s}).

### Remark 1:

The above constraints (2) to (4) form a network flow formulation without the redundant constraint (i.e., Σₜ θₜ≤1). If the generator has to be down at the end of time period T, then we only need to restrict wₜ=0 for t=T−L+2, . . . , T. If the generator is originally on, then this model can be updated by adding an additional variable w₀, updating constraint (2) to Σₜ₌₁^{T} wₜ+w₀≤1, and setting w₀=1. Meanwhile, the following are added:

1. Let y₀ₜ, t=t₀, t₀+1, . . . T, where t₀=max{L−s₀⁻, 0}; with s₀⁻ being the initial on time, represent the first on interval.

2. Add constraint w₀=Σₜ₌ₜ_{₀}^{T}y₀ₜ.

3. Add the term y₀ₜ to the left side of constraint (4).

4. Update constraints (5)-(11) to include the terms corresponding to y₀ₜ.

5. Add the shut down and generation cost terms corresponding to y₀ₜ in the objective function.

Note here that this model is more general and captures the case when initially the generator is off, by simply setting w₀=0.

### Remark 2:

The reserve component can be included in constraints (5) to (9).

For notation brevity in the next section, the feasible region describing constraints (2) to (11) is defined as set X₁. That is, X₁={(w, Ø, θ, y, z, q): Constraints (2)-(11)}. In general, network flow formulations with general convex cost functions cannot guarantee an integral solution. However, due to the problem structure, it is shown in [5] that the NUC formulation can provide an integral solution as stated below, based on the strong duality proof, i.e., the NUC formulation is the dual formulation of a revised dynamic programming formulation.

### Theorem 1:

If the general cost function ƒₜₖ^{s}(qₜₖ^{s}) is convex, then the NUC formulation provides at least one integral optimal solution for UC and the same optimal objective value as that of the corresponding mixed-integer programming formulation.

### II. Uplift Payment Minimization

The following describes the uplift payment minimization formulation and shows how the calculation of the uplift payment minimization problem can be implemented through solving a linear programming problem. The system optimization problem for a T-period UC problem (with A representing the set of generators) without considering transmission constraints run by an ISO can be abstracted as follows:

$$\begin{matrix}{Z}_{QIP}^{*} = {min}_{{w}^{j} , {φ}^{j} , {θ}^{j} , {𝓎}^{j} , {z}^{j} , {q}^{j}} {\sum }_{j ∈ Λ} {g}_{j} ( {w}^{j} , {φ}^{j} , {θ}^{j} , {𝓎}^{j} , {z}^{j} , {q}^{j} ) & ( 12 ) \\ s . t . {\sum }_{j ∈ Λ} {\sum }_{t k ∈ T K} {q}_{t k}^{j} = d & ( 13 ) \\ ( {w}^{j} , {φ}^{j} , {θ}^{j} , {𝓎}^{j} , {z}^{j} , {q}^{j} ) ∈ {X}_{I}^{j} , ∀ j ∈ Λ , & ( 14 ) \\ {𝓎}^{j} and {z}^{j} are binary , ∀ j ∈ Λ , & ( 15 )\end{matrix}$$

where Xₗ^{j} is the feasible region for generator j as shown above. Let Z_{QP}* be the optimal objective value of the above formulation without the binary restriction constraints (15). It is easy to observe that Z_{QIP}*≥Z_{QP}* because the latter is the objective value of a relaxed problem. Now consider the profit maximization problem of each generator. For a given price vector π offered by the ISO, the profit maximization problem for each generator can be described as follows:

$$\begin{matrix}{v}_{j} ( π ) = {max}_{{w}^{j ,} {φ}^{j ,} {θ}^{j ,} {𝓎}^{j} , {z}^{j} , {q}^{j}} {π}^{T} {\sum }_{t k ∈ T K} {q}_{t k}^{j} - {g}_{j} ( {w}^{j} , {φ}^{j} , {θ}^{j} , {𝓎}^{j} , {z}^{j} , {q}^{j} ) & ( 16 ) \\ s . t . ( {w}^{j} , {φ}^{j} , {θ}^{j} , {𝓎}^{j} , {z}^{j} , {q}^{j} ) ∈ {𝒳}_{l}^{j} . & ( 17 ) \\ {y}^{j} and {z}^{j} are binary & ( 18 )\end{matrix}$$

On the other hand, the profit generator j can obtain following the ISO's schedule is equal to π^{T} Σ_{tk∈TK} q̅ₜₖ^{j}−gⱼ(w̅^{j}, Ø̅^{j}, θ̅^{j}, y̅^{j}, z̅^{j}, q̅^{j}), defined as v̅ⱼ(π) where (w̅^{j}, Ø̅^{j}, θ̅^{j}, y̅^{j}, z̅^{j}, q̅^{j}) is an optimal solution for generator j in the system optimization problem corresponding to Z_{QIP}*.

Since vⱼ(π) is no smaller than v̅ⱼ(π), there is a lost opportunity cost (LOC) of each generator following the ISO for each generator. Uplift payment is triggered as described in [1] and [2] and can be represented in the following form:

$${U}_{j} ( π , {\overline{w}}^{j} , {\overline{φ}}^{j} , {\overline{θ}}^{j} , {\overline{𝓎}}^{j} , {\overline{z}}^{j} , {\overline{q}}^{j} ) = {v}_{j} ( π ) - {π}^{T} {\sum }_{t k ∈ T K} {\overline{q}}_{t k}^{j} - {g}_{j} ( {\overline{w}}^{j} , {\overline{φ}}^{j} , {\overline{θ}}^{j} , {\overline{y}}^{j} , {\overline{z}}^{j} , {\overline{q}}^{j} ) ) . \qquad ( 19 )$$

To reduce the discrepancy, we need to find an optimal price π that minimizes the total uplift cost. That is, we want to

$$\begin{matrix} {min}_{π} {\sum }_{j ∈ Λ} {U}_{j} ( π , {\overline{w}}^{j} , {\overline{φ}}^{j} , {\overline{θ}}^{j} , {\overline{y}}^{j} , {\overline{z}}^{j} , {\overline{q}}^{j} ) & ( 20 ) \\ = {min}_{π} {\sum }_{j ∈ Λ} ( {v}_{j} ( π ) - ( {π}^{T} {\sum }_{t k ∈ T K} {\overline{q}}_{t k}^{j} - {g}_{j} ( {\overline{w}}^{j} , {\overline{φ}}^{j} , {\overline{θ}}^{j} , {\overline{y}}^{j} , {\overline{z}}^{j} , {\overline{q}}^{j} ) ) ) & ( 21 ) \\ = {min}_{π} {\sum }_{j ∈ Λ} {g}_{j} ( {\overline{w}}^{j} , {\overline{φ}}^{j} , {\overline{θ}}^{j} , {\overline{y}}^{j} , {\overline{z}}^{j} , {\overline{q}}^{j} ) - ( {π}^{T} d - {\sum }_{j ∈ Λ} {v}_{j} ( π ) ) & ( 22 )\end{matrix}$$

where (21) follows from (19) and (22) follows from (13). The above (22) is equivalent to solving the following maximization problem, since Σ_{j∈Λ}gⱼ(w̅^{j}, ϕ̅^{j}, θ̅^{j}, y̅^{j}, z̅^{j}, q̅^{j}) is a fixed value (the total generation cost for the system), as indicated in [1]:

$$\begin{matrix}{max}_{π} {π}^{T} d - {\sum }_{j ∈ Λ} {v}_{j} ( π ) = {max}_{π} {π}^{T} d - {\sum }_{j ∈ Λ} ( {max}_{( {w}^{j} , {φ}^{j} , {θ}^{j} , {y}^{j} , {z}^{j} , {q}^{j} )} {π}^{T} {\sum }_{t k ∈ T K} {q}_{t k}^{j} - {g}_{j} ( {w}^{j} , {φ}^{j} , {θ}^{j} , {y}^{j} , {z}^{j} , {q}^{j} ) ) \\ s . t . ( {w}^{j} , {φ}^{j} , {θ}^{j} , {y}^{j} , {z}^{j} , {q}^{j} ) ∈ {𝒳}_{l}^{j} . & ( 23 ) \\ {y}^{j} and {z}^{j} are binary . & ( 24 ) \\ = {max}_{π} {\sum }_{j ∈ Λ} ( {min}_{( {w}^{j} , {φ}^{j} , {θ}^{j} , {y}^{j} , {z}^{j} , {q}^{j} )} {g}_{j} ( {w}^{j} , {φ}^{j} , {θ}^{j} , {y}^{j} , {z}^{j} , {q}^{j} ) - {π}^{T} {\sum }_{t k ∈ T K} {q}_{t k}^{j} ) + {π}^{T} d & ( 25 ) \\ s . t . ( {w}^{j} , {φ}^{j} , {θ}^{j} , {y}^{j} , {z}^{j} , {q}^{j} ) ∈ {𝒳}_{l}^{j} . & ( 26 ) \\ {y}^{j} and {z}^{j} are binary . & ( 27 )\end{matrix}$$

It is easy to observe that model (25)-(27) is essentially the Lagrangian relaxation of the original problem (12)-(15) to obtain Z_{QIP}* and the corresponding optimal value π, i.e., π*, is the optimal convex hull price.

Based on Theorem 1, it can be concluded that constraints (18), (24), and (27) can be relaxed. Thus, since (12)-(14) is a linear program and (25)-(26) is a Lagrangian relaxation of (12)-(14), due to strong duality theorem, the linear program (12)-(14) can be solved and the optimal convex hull price π* is equal to the dual value corresponding to the load balance constraints (13). This main conclusion is highlighted in the following theorem.

### Theorem 2:

If the general cost function ƒₜₖ^{s}(qₜₖ^{s}) is convex, then the optimal convex hull price can be obtained by solving the linear program (12)-(14), in which ƒₜₖ^{s}(qₜₖ^{s}) is approximated by a piecewise linear function and the optimal convex hull price is equal to the dual values corresponding to the load balance constraints (13).

### III. An Example

Let T=3 with d₁=70 MW, d₂=80 MW, and d₃=90 MW. There are two generators (G1 and G2) in the system. For G1, there are no start-up cost and binary decisions. The generation bounds are C₁=0 and C̅₁=40 MW. The unit generation cost in each time period is c₁=$4/MWh; c₂=$5/MWh, and c₃=$5/MWh. For G2, we have C₂=20 MW, C̅₂=100 MW, V̅₂=55 MW/h, V₂=5 MW/h and L₂=l₂=2. The start-up cost for G2 is $100. The convex generation cost for G2 is approximated by a two-piece piecewise linear function (e.g., ϕₜₖ^{s}≥100yₜₖ+qₜₖ^{s} and ϕₜₖ^{s}≥370 yₜₖ−qₜₖ^{s}). The corresponding system optimization problem using the traditional 2-Bin UC model is as follows:

min 4x₁¹+5x₁¹+5x₃¹+100(u₁²+u₂²+u₃²)+ϕ₁+ϕ₂+ϕ₃

s.t. xᵢ¹+x₁²=dᵢ,xᵢ¹≤40,20ᵢ²≤x₁²≤100yᵢ²,i=1,2,3

u₁²≤y₁²,u₁²+u₂²≤y₂²,u₂²+u₃²≤y₃²

yᵢ²−yᵢ₋₁²≤uᵢ²,i=1,2,3

x₁²≤55u₁²,xᵢ²−xᵢ₋₁²≤5yᵢ₋₁²+55(1−yᵢ₋₁²),i=2,3

xᵢ₋₁²−xᵢ²≤5yᵢ¹+100(1−yᵢ²),i=2,3

ϕᵢ≤100yᵢ²+xᵢ²,ϕᵢ≥370yᵢ²−xᵢ²,i=1,2,3

xᵢ¹≥0;yᵢ² and uᵢ² binary,i=1,2,3

We have Z_{QIP}*=$1315 with the optimal solution x̅₁¹⁼15, x̅₂¹=20, x̅₃¹=25, x̅₁²=55, x̅₂²=60, x̅₃²=65 for both the 2-Bin and NUC mixed integer linear programming (MILP) formulations. The corresponding LMPs are π₁¹=4, π₂¹=5, and π₃¹=5 (the optimal dual values corresponding to the load balance constraints in solving the economic dispatch problem when the unit commitment is fixed). Meanwhile, we have Z_{QP}^{2B}=$940 (the optimal objective value for the 2-Bin LP relaxation model) with the corresponding dual values π₁²=5.459, π₂²=5, and π₃²=5 and Z_{QP}*=$1267.27 with the corresponding dual values π₁³=4.41, π₂³=5, and π₃³=7.5 (the corresponding nonzero fractional solution is x₁¹=40, x₂¹=34, x₃¹=40, q₁₃¹=30, q₁₃²=32.7, q₁₃³=35.5, q₂₃²=13.3, q₂₃³=14.5, y₁₃=0.545, y₂₃=0.242). Using π¹, π², and π³ as the input for (25)-(26), combining (22), we can obtain the uplift payments to be $185, $141.23, and $47.75, respectively, which shows that the convex hull price provided by the NUC formulation leads to the smallest uplift payment and further, we need to solve a linear program to achieve this.

### IV. Market Clearing Process

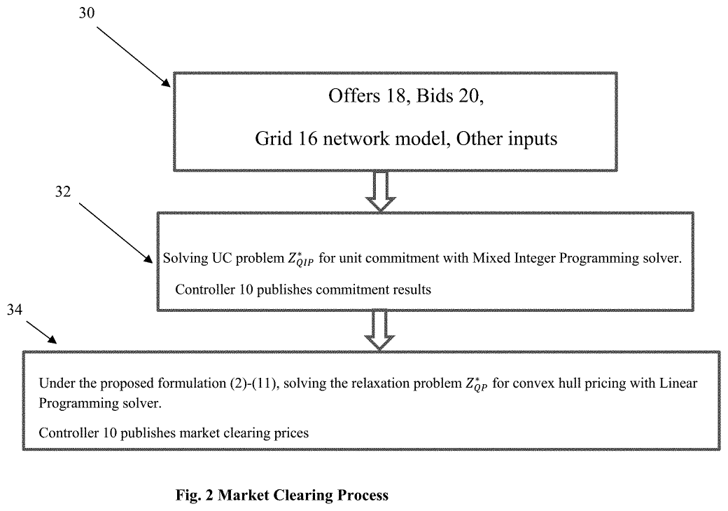

An exemplary market clearing process is shown in FIG. 2. As shown in Step 30, a controller 10 receives offers 18 and bids 20 from market participants. Input may also include the network model from the grid and other inputs. As shown in Step 32, the controller 10 may then formulate unit commitment problem Z_{QIP}*, solving with a Mixed Integer Programming solver and then publishes unit commitment results. As shown in Step 34, the controller 10 then uses the same setoff inputs to formulate pricing problem Z_{QP}* for convex hull pricing with Linear Programming solver. The controller 10 then publishes market clearing prices.

The following references are incorporated herein by reference:
[1] P. Gribik, W. Hogan, and S. Pope, “Market-clearing electricity prices and energy uplift,” Cambridge, Mass., 2007.
[2] B. Hua and R. Baldick, “A convex primal formulation for convex hull pricing,” IEEE Transactions on Power Systems, vol. 32, no. 5, pp. 3814-3823, 2017.
[3] D. A. Schiro, T. Zheng, F. Zhao, and E. Litvinov, “Convex hull pricing in electricity markets: Formulation, analysis, and implementation challenges,” IEEE Transactions on Power Systems, vol. 31, no. 5, pp. 4068-4075, 2016.
[4] C. Wang, P. B. Luh, P. Gribik, T. Peng, and L. Zhang, “Commitment cost allocation of fast-start units for approximate extended locational marginal prices,” IEEE Transactions on Power Systems, vol. 31, no. 6, pp. 4176-4184, 2016.
[5] Y. Guan, K. Pan, and K. Zhou, “Polynomial time algorithms and extended formulations for unit commitment problems,” IISE Transactions, vol. 50, no. 8, pp. 735-751, 2018 (first available at https://arxiv.org/abs/1608.00042 in July 2016).

What is claimed is:

1. A method for operating an electrical power grid where the electrical power grid includes an electrical power grid, a plurality of power generation participants providing electric power to the electrical power grid, a plurality of consumers drawing electrical power from the electrical power grid, and a controller that administers the market for the power generation participants and the consumers on the electrical power grid, the method including:
collecting bids, by the controller, from the power generation participants and the power generation recipients; and
setting, by the controller, one or more uniform prices for the providing of electric power from the power generation participants to the power generations consumers;
wherein the setting step utilizes a convex hull pricing approach;
wherein the convex hull pricing approach utilizes an integral formulation of the single-generator unit commitment problem to facilitate the calculation of an accurate convex hull price that achieves the most efficient market clearing price; and
wherein the linear program is represented as follows:
$$\begin{matrix}{Z}_{Q P}^{*} = {min}_{{w}^{j} , {φ}^{j} , {θ}^{j} , {y}^{j} , {z}^{j} , {q}^{j}} {\sum }_{j ∈ Λ} {g}_{j} ( {w}^{j} , {φ}^{j} , {θ}^{j} , {y}^{j} , {z}^{j} , {q}^{j} ) & ( 12 ) \\ s . t . {\sum }_{j ∈ Λ} {\sum }_{t k ∈ T K} {q}_{t k}^{j} = d & ( 13 ) \\ ( {w}^{j} , {φ}^{j} , {θ}^{j} , {y}^{j} , {z}^{j} , {q}^{j} ) ∈ {𝒳}_{I}^{j} , {∀}_{j} ∈ Λ , & ( 14 )\end{matrix}$$
where set X₁={(w, ϕ, θ, y, z, q): Constraints (2)-(11)} is the feasible region for generator j. Its convex hull formulation is (2)-(11):
$$\begin{matrix}s . t . {\sum }_{t = 1}^{τ} {w}_{t} \leq 1 , & ( 2 ) \\ {\sum }_{k = m i n \{ t + L - 1 , T \}}^{T} {Y}_{t k} - {\sum }_{k = L}^{t - 𝓁 - 1} {z}_{k t} = {w}_{t} , ∀ t ∈ {[ 1 , T ]}_{ℤ} , & ( 3 ) \\ {\sum }_{k = 1}^{t - L + 1} {Y}_{k t} - {\sum }_{k = t + 𝓁 + 1}^{T} {z}_{t k} = {θ}_{t} , ∀ t ∈ {[ L , T - 𝓁 - 1 ]}_{ℤ} , & ( 4 ) \\ \underline{C} {y}_{t k} \leq {q}_{t k}^{8} \leq \overline{C} {y}_{t k} , ∀ s ∈ {[ t , k ]}_{ℤ} , ∀ t k ∈ TK , & ( 5 ) \\ {q}_{t k}^{t} \leq \overline{V} {y}_{t k} , ∀ t k ∈ TK , & ( 6 ) \\ {q}_{t k}^{k} \leq \overline{V} {y}_{t k} , ∀ t k ∈ T K , k \leq T - 1 & ( 7 ) \\ {q}_{t k}^{s - 1} - {q}_{t k}^{s} \leq V {y}_{t k} , ∀ s ∈ {[ t + 1 , k ]}_{ℤ} , ∀ t k ∈ TK , & ( 8 ) \\ {q}_{t k}^{s} - {q}_{t k}^{s - 1} \leq V {y}_{t k} , ∀ s ∈ {[ t + 1 , k ]}_{ℤ} , ∀ t k ∈ TK , & ( 9 ) \\ {ψ}_{tk}^{s} - {m}_{j} {q}_{t k}^{s} \geq {n}_{j} {y}_{t k} ∀ s ∈ {[ t , k ]}_{ℤ} , ∀ tk , & ( 10 ) \\ w , θ , y , z \geq 0 , & ( 11 )\end{matrix}$$

2. The method of claim 1, wherein the improved convex hull price is π* equal to the dual values corresponding to the load balance constraints (13).

3. A method for operating an electrical power grid where the electrical power grid includes an electrical power grid, a plurality of power generation participants providing electric power to the electrical power grid, a plurality of consumers drawing electrical power from the electrical power grid, and a controller that administers the market for the power generation participants and the consumers on the electrical power grid, the method including:
collecting bids, by the controller, from the power generation participants and the power generation recipients;
formulating a unit commitment problem Z_{QIP}*, solving with a Mixed Integer Programming solver and publishing unit commitment results; and
formulating a pricing problem Z_{QP}*, for convex hull pricing with Linear Programming solver and publishing market clearing prices, where its convex hull formulation is (2)-(11):
$$\begin{matrix}s . t . {\sum }_{t = 1}^{T} {w}_{t} \leq 1 , & ( 2 ) \\ {\sum }_{k = m i n \{ t + L - 1 , T \}}^{T} {Y}_{t k} - {\sum }_{k = L}^{t - 𝓁 - 1} {z}_{k t} = {w}_{t} , ∀ t ∈ {[ 1 , T ]}_{ℤ} , & ( 3 ) \\ {\sum }_{k = 1}^{t - L + 1} {Y}_{k t} - {\sum }_{k = t + 𝓁 + 1}^{T} {z}_{t k} = {θ}_{t} , ∀ t ∈ {[ L , T - 𝓁 - 1 ]}_{ℤ} , & ( 4 ) \\ \underline{C} {y}_{t k} \leq {q}_{t k}^{8} \leq \overline{C} {y}_{t k} , ∀ s ∈ {[ t , k ]}_{ℤ} , ∀ t k ∈ TK , & ( 5 ) \\ {q}_{t k}^{t} \leq \overline{V} {y}_{t k} , ∀ t k ∈ TK , & ( 6 ) \\ {q}_{t k}^{k} \leq \overline{V} {y}_{t k} , ∀ t k ∈ T K , k \leq T - 1 & ( 7 ) \\ {q}_{t k}^{s - 1} - {q}_{t k}^{s} \leq V {y}_{t k} , ∀ s ∈ {[ t + 1 , k ]}_{ℤ} , ∀ t k ∈ TK , & ( 8 ) \\ {q}_{t k}^{s} - {q}_{t k}^{s - 1} \leq V {y}_{t k} , ∀ s ∈ {[ t + 1 , k ]}_{ℤ} , ∀ t k ∈ TK , & ( 9 ) \\ {ψ}_{tk}^{s} - {m}_{j} {q}_{t k}^{s} \geq {n}_{j} {y}_{t k} ∀ s ∈ {[ t , k ]}_{ℤ} , ∀ tk , & ( 10 ) \\ w , θ , y , z \geq 0 , & ( 11 )\end{matrix}$$
